(19) United States
(12) Patent Application Publication
(10) Pub. No.: US 2023/0260253 A1
(43) Pub. Date: Aug. 17, 2023

(54) MACHINE LEARNING APPROACH FOR RADIOGRAPHIC NON-DESTRUCTIVE TESTING

(71) Applicant: Chevron U.S.A. Inc., San Ramon, CA (US)

(72) Inventors: Oliver John Wilson, Houston, TX (US); Jarred Christopher Sharp, Houston, TX (US); Jacob Long Gleason, Kingwood, TX (US); Pablo Mauricio Calva Valderrabano, Houston, TX (US); Christine Ikram Fouad Noshi, Houston, TX (US); Michael Glynn Sens, Conroe, TX (US); Jaime Julian Perez, Houston, TX (US); Leanah Irene Heather, Houston, TX (US)

(21) Appl. No.: 18/168,917

(22) Filed: Feb. 14, 2023

Related U.S. Application Data
(60) Provisional application No. 63/310,075, filed on Feb. 14, 2022.

(51) Int. Cl. G06V 10/764; G06V 10/82; G06V 20/10

(52) U.S. Cl. CPC G06V 10/764; G06V 10/82; G06V 20/176

(57) ABSTRACT

A machine-learning model is trained using images of structures including defects and images of structures not including defects. Preprocessing is performed on the images before training the machine-learning model. The trained machine-learning model is used to classify defects within images of structures. Images of structures with defects are identified, and the probabilities of the identification/defect classification are obtained.

### CROSS-REFERENCE TO RELATED APPLICATIONS

The present application claims the benefit of U.S. Provisional Application Number 63/310,075, entitled “MACHINE LEARNING APPROACH FOR NON-DESTRUCTIVE TESTING,” which was filed on Feb. 14, 2022, the entirety of which is hereby incorporated herein by reference.

### FIELD

The present disclosure relates generally to the field of radiographic non-destructive testing.

### BACKGROUND

Non-destructive testing (NDT) may be used to inspect structures. Traditional NDT of a structure may be time-consuming and costly, as well as being prone to subjectivity of the reviewer. In some cases, traditional NDT may be inadequate. Radiography is a method used to produce images of parts or materials.

### SUMMARY

This disclosure relates to radiographic non-destructive testing. Training information, image information, and/or other information may be obtained. The training information may define training images of a structure and labeling of the training images as including the structure with one or more defects or as including the structure without the defect(s). A machine-learning model may be trained using the training images of the structure, the labeling of the training images, and/or other information. The trained machine-learning model may provide classification of input images as including the structure with defect(s) or as including the structure without defect(s) and probability of the classification of the input images. The image information may define one or more images of the structure. Classification of the image(s) of the structure, as including the structure with defect(s) or as including the structure without defect(s), and probability of the classification of the image(s) may be determined by inputting the image(s) into the trained machine-learning model.

A system for radiographic non-destructive testing may include one or more electronic storage, one or more processors and/or other components. The electronic storage may store training information, information relating to training images, information relating to a structure, information relating to labeling of training images, information relating to defects, information relating to a machine-learning model, image information, information relating to images, information relating to classification of images, and/or other information.

The processor(s) may be configured by machine-readable instructions. Executing the machine-readable instructions may cause the processor(s) to facilitate radiographic non-destructive testing. The machine-readable instructions may include one or more computer program components. The computer program components may include one or more of a training information component, a train component, an image information component, a classification component, and/or other computer program components.

The training information component may be configured to training information and/or other information. The training information may define training images of a structure and labeling of the training images as including the structure with a defect or as including the structure without the defect. In some implementations, the training images of the structure may be divided into subsets using multi-class stratification, with individual subsets representing different types of defects.

The train component may be configured to train a machine-learning model. The machine-learning model may be trained using the training images of the structure and the labeling of the training images. The trained machine-learning model may provide classification of input images as including the structure with the defect or as including the structure without the defect and probability of the classification of the input images.

In some implementations, the machine-learning model may include a convolutional neural network with multiple convolutional layers and a fully connected layer. In some implementations, the machine-learning model may include a residual neural network that requires a single-channel input.

In some implementations, the machine-learning model may be pretrained, and training of the machine-learning model using the training images of the structure and the labeling of the training images may include fine-tuning the machine-learning model using the training images of the structure and the labeling of the training images.

In some implementations, memory requirement for weights of the machine-learning model may be reduced in training using automatic mixed precision. In some implementations, memory requirement for training of the machine-learning model using the training images of the structure may be reduced using gradient accumulation.

In some implementations, the machine-learning model is trained deterministically.

In some implementations, the training images may be preprocessed before the machine-learning model is trained. The preprocessing of the training images may include changing dimension one or more training images. The dimension of the training image(s) may be changed based on rotation, padding, stretching, and/or cropping of the training image(s). The preprocessing of the training images may include changing size of one or more training images. The preprocessing of the training images may include changing exposure and/or color scale of one or more training images.

The image information component may be configured to obtaining image information and/or other information. The image information may define an image of the structure. In some implementations, the training images of the structure may include x-ray images or gamma ray images of the structure.

The classification component may be configured to determine classification of the image of the structure as including the structure with the defect or as including the structure without the defect and determine probability of the classification of the image by inputting the image into the trained machine-learning model. In some implementations, the classification of the input images as including the structure with the defect further may include classification of a type of defect within the input images and/or identification of a location and/or a size of the defect.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for radiographic non-destructive testing.

FIG. 2 illustrates an example process for radiographic non-destructive testing.

FIG. 3 illustrates an example user interface.

FIG. 4 illustrates example pre-processing of an image.

FIG. 5 illustrates example data augmentation.

### DETAILED DESCRIPTION

The present disclosure relates to radiographic non-destructive testing. A machine-learning model is trained using images of structures including defects and images of structures not including defects. Preprocessing is performed on the images before training the machine-learning model. The trained machine-learning model is used to classify defects within images of structures.

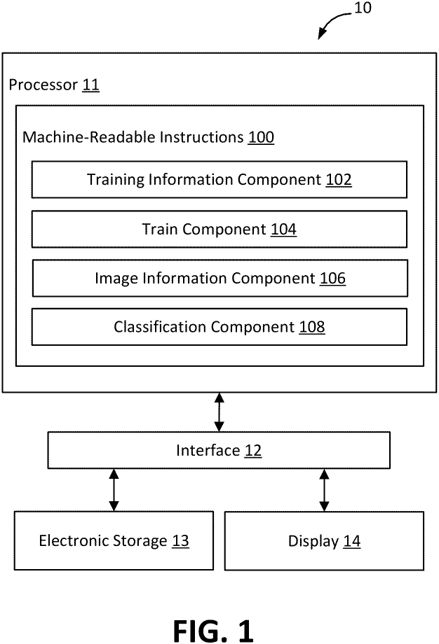

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Training information, image information, and/or other information may be obtained by the processor 11. The training information may define training images of a structure and labeling of the training images as including the structure with one or more defects or as including the structure without the defect(s). A machine-learning model may be trained by the processor 11 using the training images of the structure, the labeling of the training images, and/or other information. The trained machine-learning model may provide classification of input images as including the structure with defect(s) or as including the structure without defect(s) and probability of the classification of the input images. The image information may define one or more images of the structure. Classification of the image(s) of the structure, as including the structure with defect(s) or as including the structure without defect(s), and probability of the classification of the image(s) may be determined by the processor 11 by inputting the image(s) into the trained machine-learning model.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store training information, information relating to training images, information relating to a structure, information relating to labeling of training images, information relating to defects, information relating to a machine-learning model, image information, information relating to images, information relating to classification of images, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present training information, information relating to training images, information relating to a structure, information relating to labeling of training images, information relating to defects, information relating to a machine-learning model, image information, information relating to images, information relating to classification of images, and/or other information.

Traditional NDT includes subject matter experts reviewing images of a structure to identify defects in the structure. For example, traditional NDT for a weld may require examination by a qualified inspector who is trained to identify weld defect in images. This is a subjective process and prone to human error. Inaccurate results from NDT may result in more time being spent to reperform the NDT or further damage to the structure. For example, inaccurate results from NDT for a weld may require significant amount of reinspection and/or repair/rewelding. Unidentified defects in the weld may result in failure of associated equipment.

The present disclosure provides a machine-learning approach for NDT that increases the accuracy of defect detection, reduces errors due to human factors and subjective image interpretation, and increases the productivity of infield inspectors by prioritizing images (e.g., images classified as including defect, images classified by the machine-learning approach differently from subject matter experts) for review. The machine-learning approach for NDT may be used to improve NDT results.

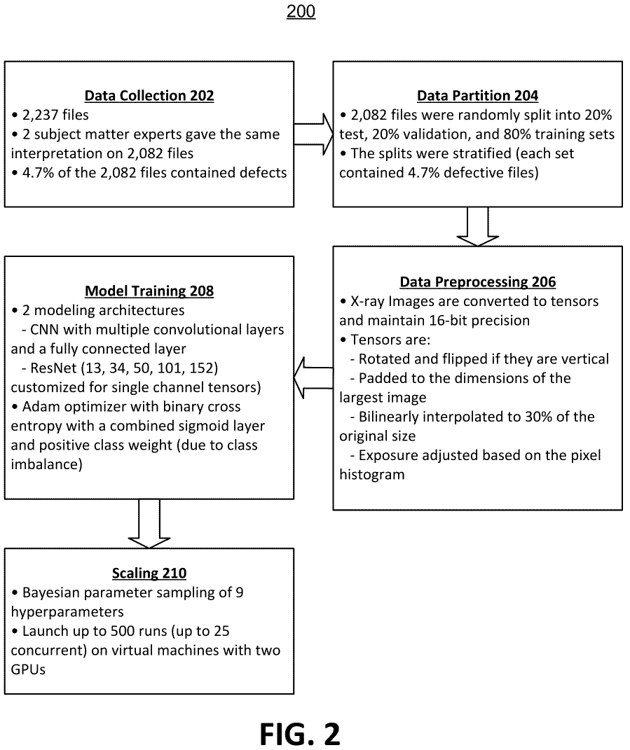

FIG. 2 illustrates an example process 200 for radiographic non-destructive testing. The values/numbers shown in FIG. 2 are merely provided as an example and are not meant to be limiting. The process 200 may start with data collection 202, in which images of a structure are obtained. The images may be reviewed by subject matter experts and labeled as including or not including defects. The labeling of the images may include other information, such as the types of defects in the images, the locations of defects in the images, and/or the size of defects in the images. Only the images that are consistently labeled by different subject matter experts may be used for training. Images with inconsistent labeling/interpretation may be filtered out from use in training machine-learning models. Such requirement may increase the reliability of defect labeling for training.

The images of the structure may include images with no defect, images with one defect, and/or images with multiple defects. Rather than using conventional stratification of the images, which split up the images by single class, multi-class stratification may be used to divide the images into a number of stratified subsets, with each subset representing a separate class of defect.

In data partition 204, the images may be partitioned for training and testing. The set of testing data set may be used to “test out” the machine-learning model(s) after training. Set of training images may be further divided into images for training and images for validation. That is, the set of training images may be split into (1) images that are used to train the machine-learning model(s) and (2) images that are used to validate the outputs of the machine-learning model(s) during training.

Data preprocessing 206 may be performed on the images to prepare the use of the images for training a machine-learning model. For example, the images maybe preprocessed to have the same/similar dimension (aspect ratio). For instance, the largest image may be identified, and smaller images may be modified into the same size and/or dimension via padding and/or stretching. Images may be rotated/flipped to make their horizon dimension larger than their vertical dimension. The images may be shrunk (e.g., using bilinear interpolation) to reduce their size for graphics processing. Exposure adjustment may be applied to the images based on the pixel histogram.

Preprocessing of the images may include conversion of the images to tensors (e.g., pixel array), and the tensors may be modified for use in training the machine-learning model and/or to be used as input to the trained machine-learning model. Use of the tensors for preprocessing may preserve high precision information contained within the images. For example, preprocessing of images may result in the images being converted into 8-bit images. If the original images have higher precision (e.g., 16-bit images), the conversion may result in loss of decimal precision. Conversion and use of the tensors for preprocessing may maintain the higher precision in the original images for training the machine-learning model and/or to be used as input to the trained machine-learning model.

Model training 208 may include training of one or more machine-learning models (e.g., convolutional neural network with multiple convolutional layers and a fully connected layer, a ResNet customized to receive single channel tensors). The machine-learning model(s) may be trained using the images and the labeling of the images. The machine-learning model(s) may be trained using transfer learning, automatic mixed precision, gradient accumulation, and/or multi-class stratification. Adam optimizer with binary cross entropy with combined sigmoid layer and positive class weight may be employed in the training of the machine-learning model(s). Scaling 210 may be performed using Bayesian parameter sampling of hyperparameters. Use of other optimization techniques is contemplated. Multiple runs may be launched on virtual machines with multiple processors (e.g., multiple GPUs). Classification performance of the trained machine-learning model(s) may be testing by inputting the images from the testing set into the trained machine-learning model(s) and comparing the classification/probability output by the trained machine-learning model(s) with the labels of the images.

Images of the structure may be input into the trained machine-learning model to classify the images as including defects or not including defects. The classification output by the trained-machine-learning model may be associated with probability. For example, an image may be classified as including the structure with a defect with a certain percentage of probability that the classification is correct.

The classification of the images and/or the probability of the classification of the image may be provided to one or more users (e.g., subject matter experts). For example, the user(s) may be provided with image identifiers for classified images, along with the classification and the probability of classification. As another example, the user(s) may be provided with image identifiers for images in which classification by a machine-learning model differs from classification by a subject matter expert. The user(s) may be provided with the classification and the probability of classification output by the machine-learning model, and the classification made (and the probability of classification if made) by the subject matter expert. The user(s) may be provided with the difference between the classification and/or probability of classification output by the machine-learning model versus those made by the subject matter expert.

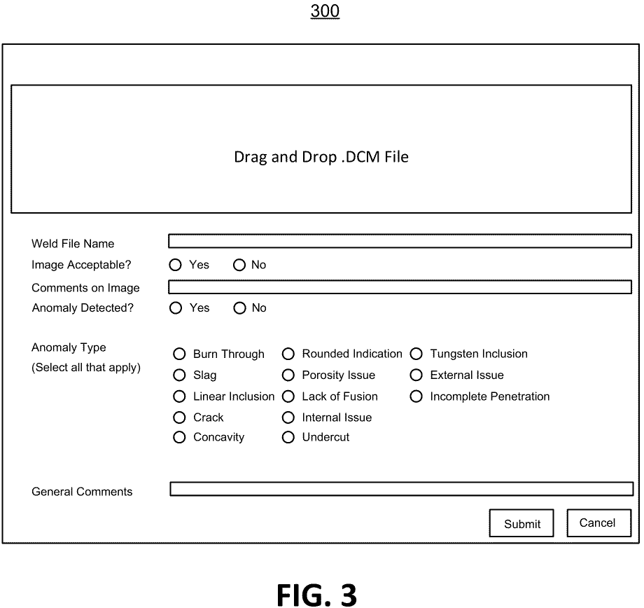

One or more parts of the process 200 may be facilitated through an interface (e.g., web interface) for subject matter experts. FIG. 3 illustrates an example user interface 300. The user interface 300 may facilitate collection of field data (images of deployed structure), analysis of field data by subject matter experts, processing of the field data for training of machine-learning model(s), and/or classification of the field data using trained machine-learning model(s). Use of other user interfaces is contemplated.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate radiographic non-destructive testing. The machine-readable instructions 100 may include one or more computer program components. The machine-readable instructions 100 may include a training information component 102, a train component 104, an image information component 106, a classification component 108, and/or other computer program components.

The training information component 102 obtain training information and/or other information. Obtaining the training information may include one or more of accessing, acquiring, analyzing, determining, examining, generating, identifying, loading, locating, opening, receiving, retrieving, reviewing, selecting, storing, and/or otherwise obtaining the training information. The training information component 102 may obtain training information from one or more locations. For example, the training information component 102 may obtain training information from a storage location, such as the electronic storage 13, electronic storage of a device accessible via a network, and/or other locations. The training information component 102 may obtain training information from one or more hardware components (e.g., a computing device, a camera) and/or one or more software components (e.g., software running on a computing device). In some implementations, the training information may be obtained from one or more users. For example, a user may interact with a computing device to identify or input training information (e.g., upload training images).

The training information may define training images of a structure. In some implementations, the training images of the structure may include x-ray images, gamma ray images, ultrasonic images, and/or other images of the structure. A structure may refer to arrangement and/or organization of one or more things. Thing(s) may be arranged and/or organized into a structure to perform one or more functions. A structure may be composed of a particular type of matter or a combination of different types of matter. For example, a structure may include a metallic, rigid structure and/or other structure. A structure may have a symmetrical shape or an asymmetrical shape. A structure may include one or more simple geometric shapes, one or more arbitrarily complex geometric shapes, and/or other geometric shapes.

In some implementations, a structure may include process equipment. In some implementations, a structure may include a metallic structure. A metallic structure may be made out of one or more metals. A metallic structure may be made wholly out of metal(s) or may include metallic components.

In some implementations, a structure may include a hollow structure, a support structure, a moving structure, and/or other structure. A hollow structure may refer to a structure that includes one or more empty spaces within the structure. The empty space(s) may be used to hold, carry, transport, and/or otherwise interact with one or more things. For example, a hollow structure may include a vehicle, a container, a tank, a pressure vessel, a pipe, and/or other hollow structure. A support structure may refer to a structure that provides support for one or more things. For example, a support structure may include an installation, a platform, a frame, a crane, a beam, and/or other support structure. A moving structure may refer to a structure that moves to perform its function. For example, a moving structure may include a turbine blade and/or other moving structure. Non-limiting examples of structures include one or more parts or entirety of offshore floating production installations (such as spars, semisubmersibles, tension leg platforms), ship/barge hulls, offshore mobile drilling units, aircrafts, space launch vehicles, wind turbine blades, pressure vessels, piping systems, ballast tanks, void tanks, and cargo tanks. Other types of structures are contemplated.

The training information may define labeling of the training images as including the structure with defect(s) or as including the structure without defect(s). A defect may refer to a physical problem, a weakness, an imperfection, an anomaly, and/or a fault in the structure. For example, for a metallic structure (e.g., weld), a defect may include one or more of burn through, slag, linear inclusion, crack, concavity, rounded indication, porosity issue, lack of fusion, internal issue, undercut, tungsten inclusion, external issue, and/or incomplete penetration. Other types of defects are contemplated. In some implementations, labeling of the training images may further include labeling of the type(s) of defects within the training images, identification of location(s) of the defect(s) within the training images, and/or identification of the size(s) of the defect(s) within the training images. Other labeling of training images is contemplated.

The train component 104 may be configured to train one or more machine-learning models. The machine-learning model(s) may be trained using the training images of the structure, the labeling of the training images, and/or other information. The differences in the labeling of the training images (e.g., as including defect, as not including defect, as including specific type of defect) may be used to train the machine-learning model(s) to identify defects in images (e.g., as including defect, as not including defect, as including specific type of defect).

In some implementations, the machine-learning model(s) may be trained using transfer learning, automatic mixed precision, gradient accumulation, and/or multi-class stratification. With respect to transfer learning, the machine-learning model(s) may have been pretrained using a general image data set (e.g., including images of structures, images of defects, images of other things) and the training images of the structure and the labeling of the training images may be used fine-tune the machine-learning model(s). Use of transfer learning may allow the machine-learning model(s) to be trained in a shorter amount of time.

With respect to automatic mixed precision, use of long floating values for training may increase computation costs (e.g., greater memory requirement, greater processing time) of training. To reduce computation costs of training, a master copy of weights may be stored in single-precision floating-point format (float32). The weights may be converted to half-precision floating-point format (float16) for training iteration. The master weights may be updated using the weight gradients during the optimizer step.

With respect to gradient accumulation, training the machine-learning model(s) using the entire set of training images at once may require more memory than is available. To enable training of the machine-learning model(s) with reduced memory cost, the training data (images of the structured with labeling) may be split into batches. Loss and gradients may be calculated after training with individual batches. The gradients may be accumulated over consecutive batches and the parameters of the machine-learning model(s) may be updated based on the cumulative gradient after a certain number of batches have been run. Use of gradient accumulation may reduce the memory requirements for the training at the expense of longer training time.

With respect to multi-class stratification, training images may include images of structure with no defect, with one defect, or with multiple defects. Multi-class stratification may divide the training images into a number of stratified subsets, each representing a separate class. Multi-class stratification may be used to divide the training into subsets of different defects (e.g., burn through, slag, linear inclusion, crack, concavity, rounded indication, porosity issue, lack of fusion, internal issue, undercut, tungsten inclusion, external issue, incomplete penetration). Each subset may contain an equal proportion of data points from each class, ensuring that the machine-learning model(s) are trained on an even distribution of the different classes. Multi-class stratification may prevent the machine-learning model(s) from developing a bias towards any particular class, as each class is represented equally in the training images. Multi-class stratification may be used to split the training in both the training set and the validation/test set so that both combinations of multiple structural defects are present in both training and validation/test sets.

Training may be performed using determinism. Deterministic training may include controlled training of the machine-learning model(s) so that the training is reproducible. With deterministic training, when the parameters of training are fixed, a machine-learning model may be trained in the same way to produce the same output. Training a machine-learning model using the same training parameters may result in the same trained model. Performance of the trained output may not depend on randomness.

A trained machine-learning model may provide classification of input images (images that are input into the trained machine-learning model) as including the structure with defect(s) or as including the structure without defect(s) and probability of the classification of the input images. The trained-machine-learning model may provide information on whether the input image includes defect(s) and the probability that its identification on the defect is correct.

In some implementations, the classification of the input images as including the structure with defect(s) may further include classification of one or more types of defect within the input images. Rather than simply providing information on whether or not an input image includes a defect, the machine-learning model may provide information on the type(s) of defect included in the image.

In some implementations, the classification of the input images as including the structure with defect(s) may further include identification of location(s) and/or size(s) of the defect(s). The machine-learning model may provide information on where the defect(s) are located in the input images and/or how big/small the defect(s) are in the input images.

In some implementations, the machine-learning model(s) may include one or more convolutional neural networks with multiple convolutional layers and a fully connected layer. In some implementations, the machine-learning model(s) may include one or more residual neural networks that requires a single-channel input. For example, the machine-learning model(s) may include a ResNet modified to receive a single-channel input rather than a three-channel input. Use of single-channel input residual neural networks may provide resource savings (e.g., in terms of processing/memory cost of running the machine-learning model(s)). For example, the images of the structure may be black and white images, and use of multiple channel residual neural networks may waste resources because two of the channels may not contain useful information or may include duplicative information (e.g., duplicate the black and white channel information). Use of other architectures for machine-learning model(s) is contemplated.

In some implementations, the training images may be preprocessed before the machine-learning model(s) are trained. The preprocessing of the training images may include grouping, deduplicating, and/or standardization of the training images.

The preprocessing of the training images may include changing dimension (aspect ratio) of one or more of the training images. The dimension of the training image(s) may be changed based on rotation, padding, stretching, cropping, and/or other manipulation of the training image(s). The dimensions of the training image(s) may be changed so that the training images have the same/similar dimension (e.g., rotated to landscape orientation, have a specific aspect ratio or have an aspect ratio that fall within acceptable ranges of aspect ratios).

The preprocessing of the training images may include changing size (resolution) of one or more of the training images. For example, the size of the training image(s) may be reduced. Reducing the size of the training image(s) may provide resource savings.

The preprocessing of the training images may include changing exposure and/or color scale of one or more of the training images. For example, exposure and/or color scale of the training images may be changed to highlight any defects within the images. For example, the exposure of one or more of the training images may be adjusted based on pixel histogram of the training images. The exposure may be adjusted so that all of the training images have the same/similar histogram (have the same/similar distribution of pixel values). For example, exposure of training image(s) may be changed so that the training images have a specific histogram or have a histogram that fall within acceptable ranges of histograms.

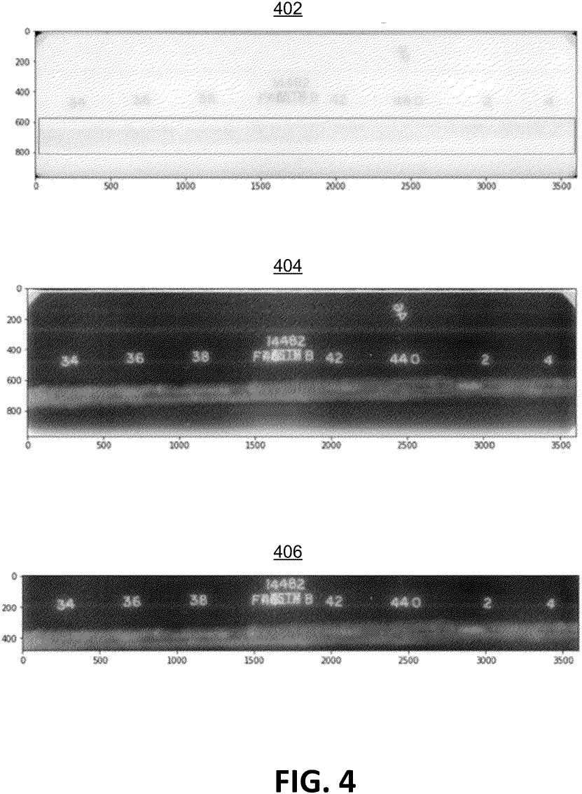

FIG. 4 illustrates example pre-processing of an image 402. In FIG. 4, exposure of the image 404 may be changed to generate an exposure-changed image 404. The exposure-changed image 404 may be cropped to generate a cropped and exposure-changed image 406. Other pre-processing of images is contemplated.

The preprocessing of the training images may include manipulation of the training images to increase the number of training images that include the structure with defect(s) (data augmentation). Manipulation of the training images may include distortion of one or more visual aspects of the training images. For example, the training images may be rotated, skewed, stretched, and/or squeezed to generate additional training images.

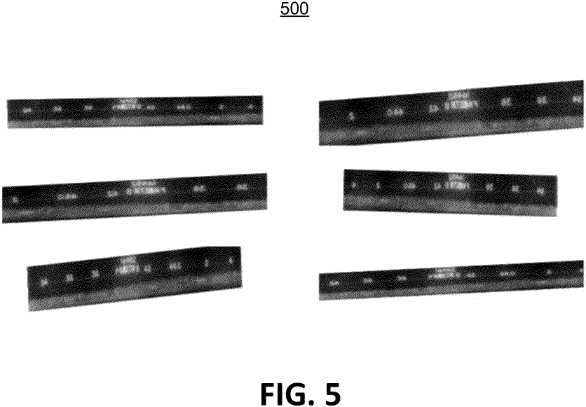

FIG. 5 illustrates example data augmentation 500. In the data augmentation 500, the cropped and exposure-changed image 406 may be manipulated to generate additional images of a structure including a defect. Other data augmentation is contemplated.

The image information component 106 may be configured to obtain image information and/or other information. Obtaining the image information may include one or more of accessing, acquiring, analyzing, determining, examining, generating, identifying, loading, locating, opening, receiving, retrieving, reviewing, selecting, storing, and/or otherwise obtaining the image information. The image information component 106 may obtain image information from one or more locations. For example, the image information component 106 may obtain image information from a storage location, such as the electronic storage 13, electronic storage of a device accessible via a network, and/or other locations. The image information component 106 may obtain image information from one or more hardware components (e.g., a computing device, a camera) and/or one or more software components (e.g., software running on a computing device). In some implementations, the image information may be obtained from one or more users. For example, a user may interact with a computing device to identify or input image information (e.g., upload images to be classified).

The image information may define one or more images of the structure. In some implementations, the image(s) may include one or more video frames. That is, rather than (or in addition to) obtaining photographs of a structure for NDT, one or more videos of the structure may be obtained for NDT.

The classification component 108 may be configured to determine classification of the image(s) of the structure as including the structure with defect(s) or as including the structure without defect(s) and determine probability of the classification of the image(s). The classification of the image(s) and the probability of the classification of the image(s) may be determined by inputting the image(s) into the trained machine-learning model(s). The trained machine-learning model(s) may output both classification of the image(s) and the probability of the classification provided by the trained machine-learning model.

For example, the trained-machine-learning model may output, for an image, whether or not the image includes defect(s) and the probability that the defect identification by the trained machine-learning model is correct. The trained-machine-learning model may output other information about the image, such as the type(s) of defects within the image, the location of the defects within the image, and/or the size of the defect(s) within the image, as well as the corresponding probabilities. The output of the trained-machine-learning model (e.g., classification and corresponding probability of defects, types of defects, locations of defects, sizes of defects) may be presented on the display 14.

One or more maintenance operations for the structure may be facilitated based on the output of the trained-machine-learning model. A maintenance operation for the structure may refer to an operation to fix, preserve, replace, restore, and/or otherwise maintain the health/usage of the structure. Performing a maintenance operation may include carrying out, scheduling, initiating, and/or otherwise performing the maintenance operation. For example, based on the detection of a defect in the structure by the trained-machine-learning model (e.g., detection of a defect with a threshold probability, detection of a certain type of defect, detection of a defect in a certain location, detection of a defect of a certain size, detection of a certain number of defects), a maintenance operation to check the structure for the defect and fix the defect may be scheduled and carried out. In some implementations, based on the detection of a defect in the structure, one or more alarms/communications may be generated to inform users of the defect in the structure.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hardwired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for radiographic non-destructive testing, the system comprising:
one or more physical processors configured by machine-readable instructions to:
obtain training information, the training information defining training images of a structure and labeling of the training images as including the structure with a defect or as including the structure without the defect;
train a machine-learning model using the training images of the structure and the labeling of the training images, wherein the trained machine-learning model provides classification of input images as including the structure with the defect or as including the structure without the defect and probability of the classification of the input images;
obtaining image information, the image information defining an image of the structure; and
determine classification of the image of the structure as including the structure with the defect or as including the structure without the defect and determine probability of the classification of the image by inputting the image into the trained machine-learning model.

2. The system of claim 1, wherein the training images of the structure includes x-ray images or gamma ray images of the structure.

3. The system of claim 1, wherein the training images are preprocessed before the machine-learning model is trained.

4. The system of claim 3, wherein the preprocessing of the training images includes changing dimension of one or more of the training images.

5. The system of claim 4, wherein the dimension of the one or more of the training images is changed based on rotation, padding, stretching, and/or cropping of the one or more of the training images.

6. The system of claim 3, wherein the preprocessing of the training images includes changing size of one or more of the training images.

7. The system of claim 3, wherein the preprocessing of the training images includes changing exposure and/or color scale of one or more of the training images.

8. The system of claim 1, wherein the machine-learning model includes a convolutional neural network with multiple convolutional layers and a fully connected layer.

9. The system of claim 1, wherein the machine-learning model includes a residual neural network that requires a single-channel input.

10. The system of claim 1, wherein the classification of the input images as including the structure with the defect further includes classification of a type of defect within the input images and/or identification of a location and/or a size of the defect.

11. The system of claim 1, wherein the training images of the structure are divided into subsets using multi-class stratification, individual subsets representing different types of defects.

12. The system of claim 1, wherein the machine-learning model is pretrained, and training of the machine-learning model using the training images of the structure and the labeling of the training images includes fine-tuning the machine-learning model using the training images of the structure and the labeling of the training images.

13. The system of claim 1, wherein memory requirement for weights of the machine-learning model is reduced in training using automatic mixed precision.

14. The system of claim 1, wherein memory requirement for training of the machine-learning model using the training images of the structure is reduced using gradient accumulation.

15. The system of claim 1, wherein the machine-learning model is trained deterministically.
